(19) United States
(12) Patent Application Publication
(10) Pub. No.: US 2015/0268805 A1
(43) Pub. Date: Sep. 24, 2015

(54) USER INTERFACE TO OPEN A DIFFERENT EBOOK RESPONSIVE TO A USER GESTURE

(71) Applicant: Kobo Incorporated, Toronto (CA)

(72) Inventor: Sneha PATEL, Toronto (CA)

(73) Assignee: Kobo Incorporated, Toronto (CA)

(21) Appl. No.: 14/220,429

(22) Filed: Mar. 20, 2014

(51) Int. Cl. G06F 3/0483; G06F 3/0484

(52) U.S. Cl. CPC G06F 3/0483; G06F 3/04847; G06F 3/04842

(57) ABSTRACT

System and method for providing a short cut to open a different electronic document in a book reading GUI in response to a user gesture. A book reading graphical user interface (GUI) is configured to display content of a current book and, responsive to a user pinch-in gesture, present a plurality of estimated user-intended reading materials to facilitate user selection for next reading. The select plurality of electronic documents may be the last few documents recently displayed in the GUI. A user can select an electronic document by clicking the corresponding visual object. Alternatively, the user can return to the current book by using a pinch-out gesture.

### TECHNICAL FIELD

The present disclosure relates generally to the field of electronic books, and, more specifically, to the field of graphical user interfaces for electronic books.

### BACKGROUND

The use of electronic devices to read books, newspapers and magazines in electronic format has become increasingly commonplace due to the numerous significant advantages afforded by such devices over conventional paper print. For example, comparing to paper print, an electronic reading device can hold much greater amounts of information, allow immediate access to new books, personalize the reading display format, and facilitate night reading, etc. Electronic reading devices can be implemented as dedicated reading devices, e.g., e-readers, as well as general-purpose electronic devices, such as desktop, laptop and hand-held computers.

During a reading session using a reading experience graphical user interface (GUI) for example, a user often wants to switch from reading one reading material to another. Conventionally, each switch involves a series of user interactions with the reading GUI. For instance, a user needs to close the current reading material, locate the directory that contains the intended reading material, select the intended reading material and finally confirm to open it for reading. Users may find this practice time consuming. Moreover, a user may forget the directory of intended reading material and have to go through multiple tries to locate the correct directory, even though the file may have recently been displayed in the reading GUI.

### SUMMARY OF THE INVENTION

Therefore, it would be advantageous to provide a mechanism and system to facilitate an ebook reader to switch from one reading material to another.

Embodiments of the present disclosure employ a reading experience graphical user interface (GUI) configured to present visual objects representing a select plurality of electronic documents in response to a user pinch-in gesture to facilitate a user's selection of a next electronic document for reading. The select plurality of electronic documents are determined based an estimation on the intended reading materials. Then, the user can select an electronic document by clicking the corresponding visual object. Alternatively, the user can return to the current book by using a pinch-out gesture.

For example, the last few books that were recently displayed in the reading experience GUI may be presented on-screen for the user's selection. Therefore, a user can conveniently have an overview of the reading materials that he or she recently read by simply using a single gesture during a reading experience. This shortcut approach eliminates the need for the user to manually locate the corresponding directory and search for the intended reading material. Thus, advantageously, a user can quickly locate and select the desired reading material using an intuitive input.

In one embodiment of the present disclosure, a computer implemented method comprises: (1) rendering on the touch sensitive display an on-screen graphical user interface (GUI) that facilitates electronic reading; (2) displaying content of a first electronic book within the on-screen GUI; (3) detecting an indication of a user gesture via the touch sensitive display during the displaying; (4) identifying a plurality of electronic books that have displayed on the on-screen GUI prior to displaying content of the first electronic book; and (5) responsive to the detecting, contemporaneously rendering a plurality of user-selectable objects within the on-screen GUI, wherein each user-selectable object represents a respective electronic book of the plurality of electronic books.

In one embodiment, the user gesture may be a multi-point touch pinch gesture. The method may further comprise: detecting an indication of a user selection on a user-selectable object that represents the second electronic book; responsive to the user selection, accessing content of the second electronic book; and displaying the content of the second electronic book within the on-screen GUI. The method may further comprise: responsive to a user instruction, removing the plurality of user-selectable objects from the on-screen GUI; and subsequent to the removing, displaying content of the first electronic book on the on-screen GUI. The plurality of electronic books may comprise at least four electronic books that have been previously displayed within the on-screen GUI immediately before the display of content of the first electronic book.

In another embodiment of the present disclosure, a non-transitory computer-readable storage medium embodying instructions that, when executed by a processing device, cause the processing device to perform a method of facilitating user selection of an electronic document for reading. The method comprises: (1) rendering an on-screen graphical user interface (GUI) for reading on the touchscreen display device; (2) displaying content of a first electronic document within the on-screen GUI; (3) detecting an indication of a user pinch-in gesture during the displaying via the touchscreen display device; (4) identifying a select plurality of electronic documents that were previously read using the on-screen GUI prior to the displaying content of the first electronic documents; and (5) responsive to the detecting, rendering a plurality of visual objects within the on-screen GUI, wherein each visual object represents a respective electronic document of the select plurality of electronic documents.

In another embodiment of the present disclosure, a system comprises: a touch sensitive display device configured to detect user gesture input; a processor coupled to the touch sensitive display device; and memory coupled to the processor and comprising instructions that, when executed by the processor, cause the system to perform a method of displaying content related to electronic books. The method comprising: (1) rendering an on-screen graphical user interface (GUI) for reading on the touch sensitive display device; (2) displaying content of a first electronic book on the on-screen GUI; (3) detecting an indication of a user gesture via the touch sensitive display device during the displaying; (4) identifying a plurality of electronic books that were read using the on-screen GUI prior to displaying content of the first electronic book, the plurality of electronic books comprising a second electronic book; (5) responsive to the detecting, contemporaneously rendering a plurality of user-selectable objects in the on-screen GUI, wherein each user-selectable object represents a respective electronic book of the plurality of electronic books; (6) receiving a user selection on a user-selectable object that selects the second electronic book; and (7) displaying content of the second electronic book in the on-screen GUI.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1A illustrates an exemplary reading experience GUI configured to display content of a current electronic document (Document A) and receive a user gesture input as a user instruction to display a select set of electronic documents in accordance with an embodiment of the present disclosure.

FIG. 1B illustrates the exemplary reading experience GUI configured to switch to displaying content of an electronic document (Document B) responsive to a user selection from the array of visual objects representing the select set of electronic documents in accordance with an embodiment of the present disclosure.

FIG. 1C illustrates the exemplary reading experience GUI configured to display a select set of electronic documents that are determined based on the reading history of the user in accordance with an embodiment of the present disclosure.

FIG. 1D illustrates the exemplary reading experience GUI configured to revert from displaying the array of visual representations to displaying the current document (Document A) responsive to a pinch-out gesture in accordance with an embodiment of the present disclosure.

FIG. 1E illustrates exemplary user gestures inputs that can be recognized as user instructions to switch between two GUI windows in accordance with an embodiment of the present disclosure.

FIG. 2 is a flow chart depicting an exemplary computer implemented method of automatically presenting a selection of electronic documents in a reading experience GUI responsive to a user pinch-in gesture in accordance with an embodiment of the present disclosure.

FIG. 3 is a block diagram illustrating an exemplary computing system including a reading experience program that can determine and present a selection of estimated user-intended next readings responsive to a user gesture input according to an embodiment of the present disclosure.

FIG. 4 illustrates an exemplary method of determining a set of estimated user intended next readings in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### NOTATION AND NOMENCLATURE

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### Shortcut to Open a Different Ebook Responsive to a User Gesture

Overall, embodiments of the present disclosure employ a computer implemented method of presenting a reading experience graphical user interface (GUI) configured to display an array of clickable objects that representing a select set of electronic documents in response to a user gesture detected via a touch sensitive display device. The user gesture may be a multi-point touch “pinch-in” gesture interacting with the reading experience GUI. A user can click a clickable object to select a desired electronic document. In response, the reading experience GUI displays the content of the selected electronic document.

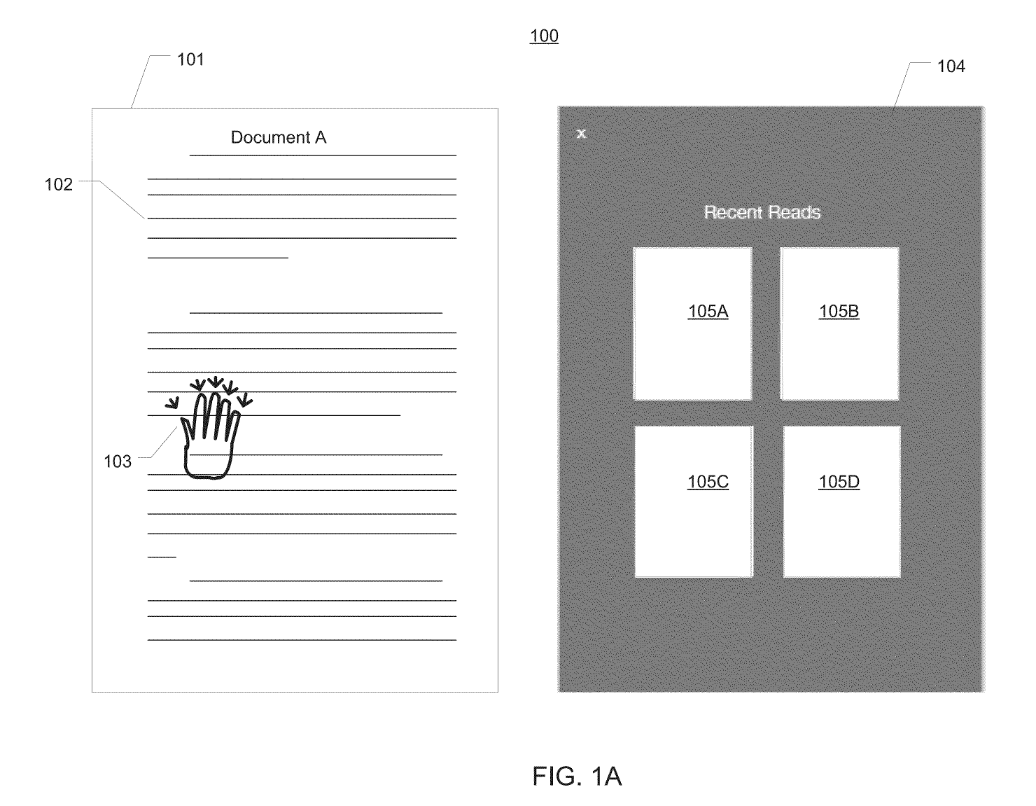

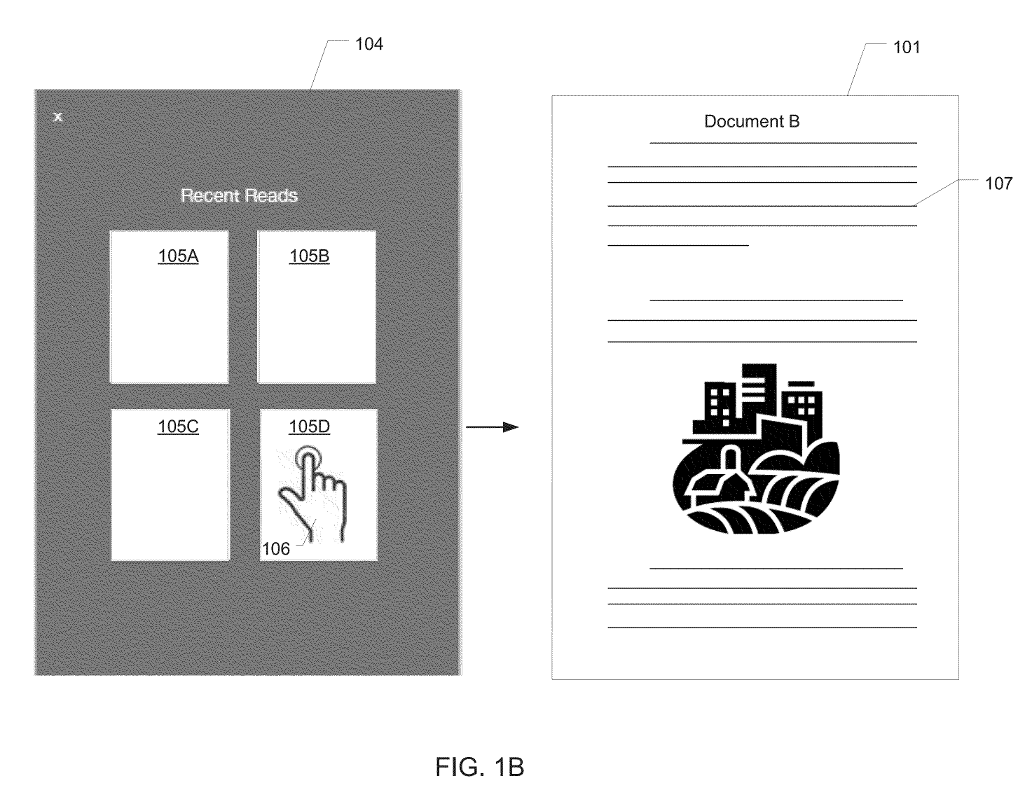

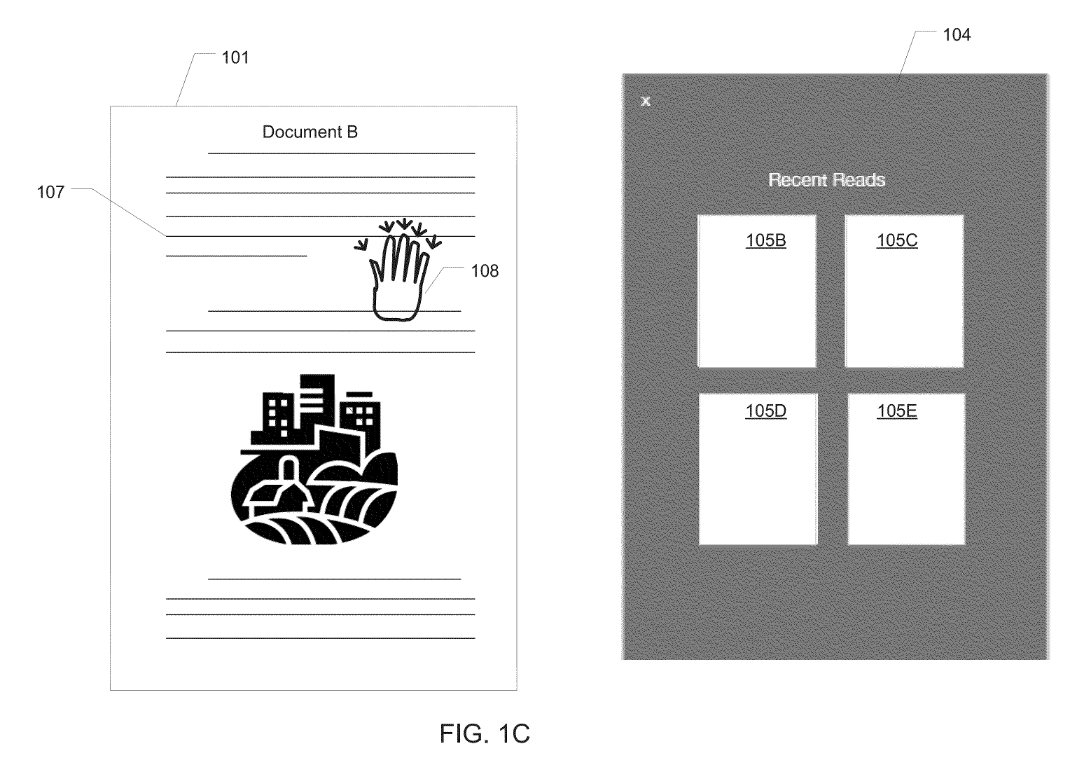

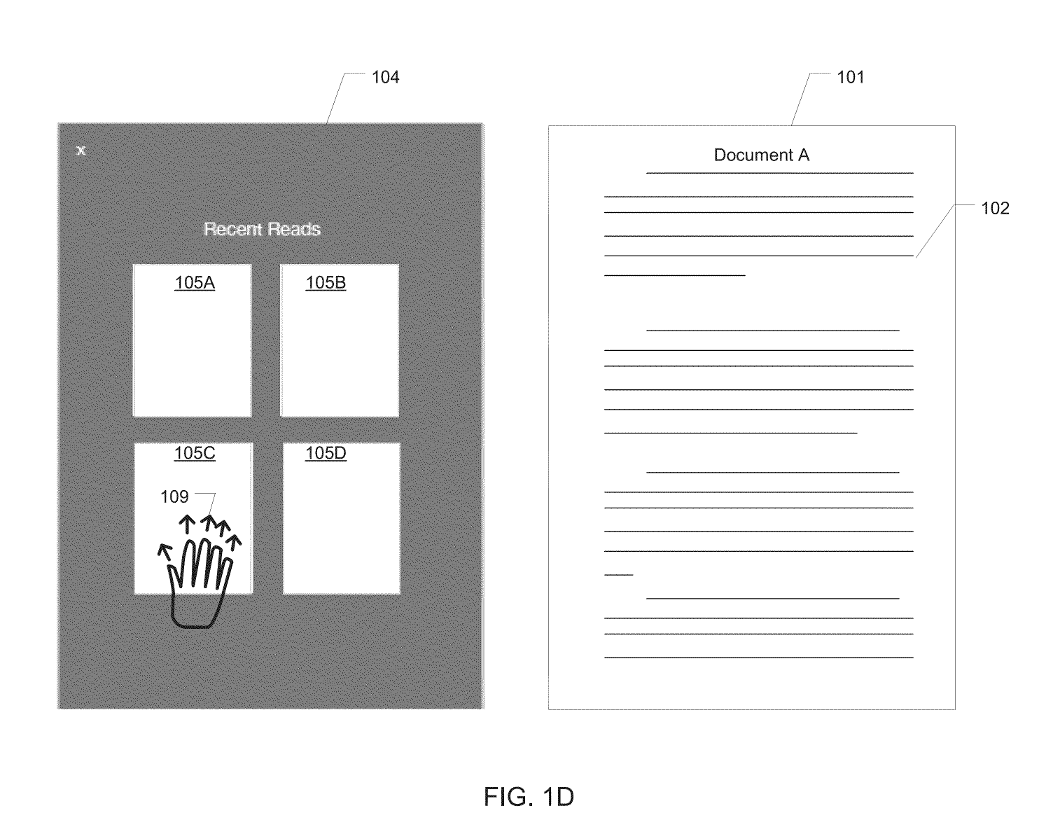

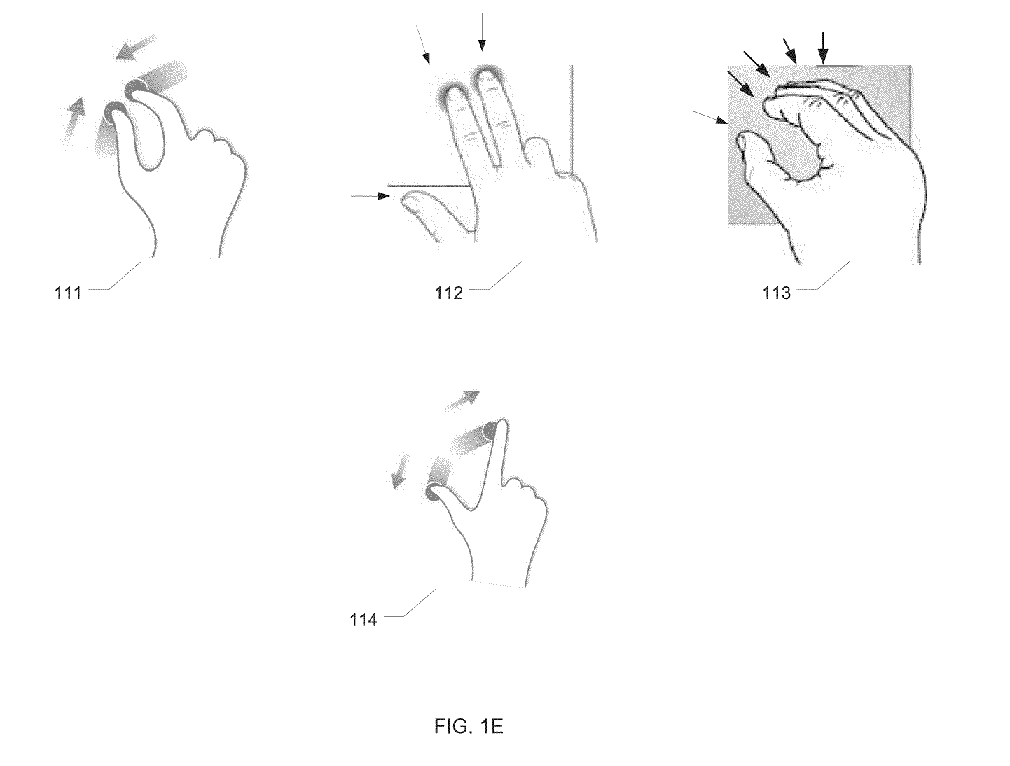

FIG. 1A illustrates an exemplary reading experience GUI 100 configured to display content of a current electronic document 102 (Document A) and receive a user gesture input 103 as a user instruction to display a select set of electronic documents 105A-105D in accordance with an embodiment of the present disclosure. As illustrates, the reading experience GUI 100 presents content of a current document 102 (Document A) within a content display GUI window 101 on a touchscreen display (not explicitly shown). Then a user pinch-in gesture 103 is detected via the touchscreen display. In this example, the pinch-in gesture 103 is a five touch points (five fingers) pinch-in gesture.

In response, a GUI window 104 encompassing an array of visual objects 105A-105D is automatically displayed within the reading experience GUI 100, e.g., by overlaying on the GUI window 101 or as a new GUI window. Each of the visual objects 105A-105D provides a visual representation of an electronic document that can also be displayed within the reading experience GUI 100. The set of documents represented by the visual objects 105A-105D are automatically selected based on an estimation on what the user intends to read next. Thus, the array of visual objects provide an overview of an estimated selection of intended reading materials, and thereby facilitate user selection on the next reading material. In some embodiments, the set of documents may be the last few books that the user just read using the reading experience GUI 100. As a result, a reading experience GUI according to the present disclosure advantageously provides a short cut to a set of documents that the user may want to read next in response to a user gesture.

It will be appreciated that after the user removes his or her hand from the display device, after the pinch-in, the display of the selected set of ebooks window 104 remains displayed on the screen.

FIG. 1B illustrates the exemplary reading experience GUI 100 configured to switch to displaying the content of an electronic document 107 (Document B) responsive to a user selection input 106 with the array of visual objects representing the select set of electronic documents 105A-105D in accordance with an embodiment of the present disclosure. As shown, the user touches and selects the visual object 105D that represents Document B in the GUI window 104, which prompts display the content of Document B 107 in the GUI window 101.

FIG. 1C illustrates the exemplary reading experience GUI 100 configured to display a select set of electronic documents 105B-105E that are determined based on the reading history of the user in accordance with an embodiment of the present disclosure. As shown, if user pinch-in gesture input 108 is received while the Document B 107 (the current document) is displayed, another array of visual objects 105B-105E corresponding to the last four documents are displayed in the GUI window 104, including the visual objects 105E corresponds to Document A (as 102 in FIG. 1A) because Document A was displayed just before Document B (the current document).

FIG. 1D illustrates the exemplary reading experience GUI 100 configured to revert from displaying the array of visual representations 105A-105D to displaying the current document 102 (Document A) responsive to a pinch-out gesture in accordance with an embodiment of the present disclosure. In this example, assuming Document A content was being displayed as the current reading before the GUI window 104 is prompted responsive to the user pinch-in gesture, as shown in FIG. 1A. Then, upon receiving a user pinch-out gesture applied on any location in the GUI window 104, Document A 101 is displayed again, as shown in FIG. 1D.

It will be appreciated that a selection of electronic documents that can be displayed in a reading experience GUI can include electronic magazines, newspapers, or a text files that are possibly accompanied with images, videos or other media formats. Further, the reading experience GUI windows 101 and 104 may include various additional widgets, icons, and graphical objects configured to perform respective functions that are well known in the art.

It will be appreciated that the estimated intended documents can be determined by various suitable criteria and methods which may be configurable by a user of the reading experience program. In some embodiments, the selection of electronic documents may be a number of electronic documents that have been previously displayed using said reading experience GUI 100 immediately before the current document 102. In some embodiments, the selection may only include most frequently opened documents using the reading experience GUI 100, e.g., in a predefined period. In some embodiments, only the documents that the user has not finished reading are included in the selection for presentation. The selection of electronic documents may have the same or different document types, formats, categories, and etc.

In some embodiments, the selection of electronic documents may be user-specific, for example if the reading experience program is capable of recognizing individual users by their log-in information. A reading history of the user may be recorded and accessed to determine the selection of electronic documents. The selection of documents may be identified and accessed from a local storage device of the electronic reader, or remotely through a network from another device, or a combination thereof.

It will be appreciated that the array of visual objects, e.g., 105A-105D in FIG. 1A, can be arranged and presented in any suitable format, pattern or order, e.g., as a cascade or a stack. The selection electronic documents may include any number of documents which may be configurable by a user through the reading experience program. The visual objects may be book covers, last visited pages, or writing descriptions of corresponding documents, or any other visual objects representative of the corresponding documents.

In the foregoing illustrated embodiments, the user gesture that is recognized and processed as a user instruction to invoke a presentation of a selection of documents is be a multi-point touch “pinch-in” gesture. In some embodiments, a pinch-in gesture for this purpose may be defined as a two-finger, three-finger, four-finger, or five-finger pinch-in gesture. FIG. 1E illustrates exemplary user gestures inputs that can be recognized as user instructions to switch between the GUI window 104 and GUI window 101 in accordance with an embodiment of the present disclosure. The diagrams 111, 112, and 113 respectively illustrates a two-finger, three-finger and five-finger pinch-in (or pinch close) gesture that can be used to instruct the GUI 100 to switch from the content display window 101 to the window 104 for displaying an array of visual objects (e.g. 105A-105D) representing a select set of documents. The diagram 114 illustrates a two-finger pinch-out (or pinch-open) gesture that can be used instruct the GUI 100 to switch from the GUI window 104 to the GUI window 101.

In some embodiments, such a user instruction may be received and processed regardless of the orientation, velocity, scale, or magnitude of a pinch-in gesture. However, in some other embodiments, such a user instruction is limited to using gestures having a certain set of attributes in terms of the number of touch points, orientation, velocity, scale, magnitude, etc.

In some other embodiments, any other suitable user input that can be recognized and processed by an electronic reader can be defined to bring up a set of visual objects to facilitate the user to select the next reading. For instance, such a user input may be a swiping up gesture or swiping down gesture, e.g., with a predefined path. The swiping gesture may be a two-finger swiping gesture. The user input may also be a combination of simple gestures, e.g., a pinch-in gesture following by a pinch-out gesture.

Furthermore, such a user input may correspond to a user interaction with an on-screen graphical object (e.g., a selectable button) configured to bring up a set of visual objects to facilitate the user to select the next reading.

In still some other embodiments, a set of visual objects showing a select set of suggested next readings (e.g., last few readings) may be tagged and/or presented in a reading menu. A user may open an intended document by selecting such a visual object therefrom.

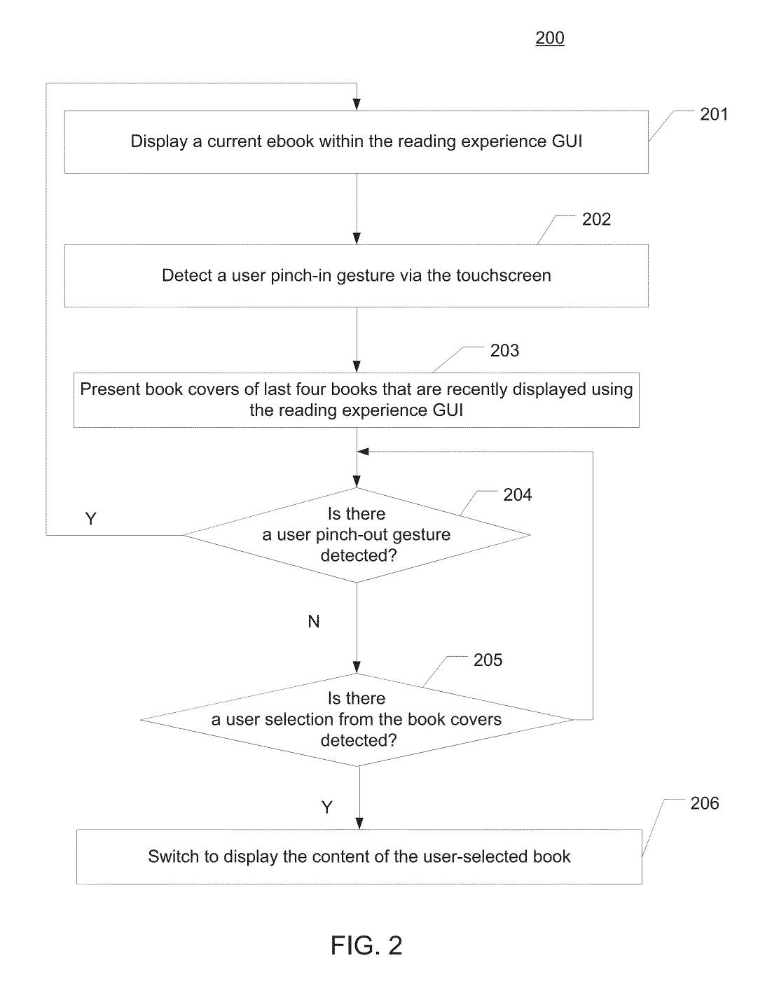

FIG. 2 is a flow chart depicting an exemplary computer implemented method 200 of automatically presenting a selection of electronic documents in a reading experience GUI responsive to a user pinch-in gesture in accordance with an embodiment of the present disclosure. Method 200 may be implemented as a software program on an electronic reading device as an integral part of a reading experience program, or a separate application program.

At 201, the content of the current ebook is displayed on the reading experience GUI. At 202, a user pinch-in gesture is detected via the touchscreen. In response to the detection, book covers of the last four books that have been recently displayed in the reading experience GUI are presented at 203. However, it will be appreciated that the present disclosure is not limited to any specific entry GUI window that can lead to the GUI window encompassing the plurality of visual objects, e.g., 105A-105D in FIG. 1A.

If a user pinch-out gesture, or an expand gesture, is detected at 204, the reading experience GUI interprets it as a user instruction to undo the user request for presenting a selection of other books. Accordingly, the content of the current ebook is re-displayed. Otherwise, if a user selection on one of the book covers is detected, the reading experience GUI switches to display the content of the selected document.

As discussed in greater detail with reference to the user pinch-in gesture, any other suitable gesture can be defined as a user instruction to switching from presenting a selection of other books to re-displaying the current book, e.g., to reverse the effect of a pinch-in gesture.

The method of presenting a selection of estimated user-intended reading materials responsive to a user gesture input according to the present disclosure can be implemented on any suitable electronic reading device, including a desktop, portable computers, personal digital assistance (PDAs), mobile, phone, e-readers, touchpads, tablets, and etc.

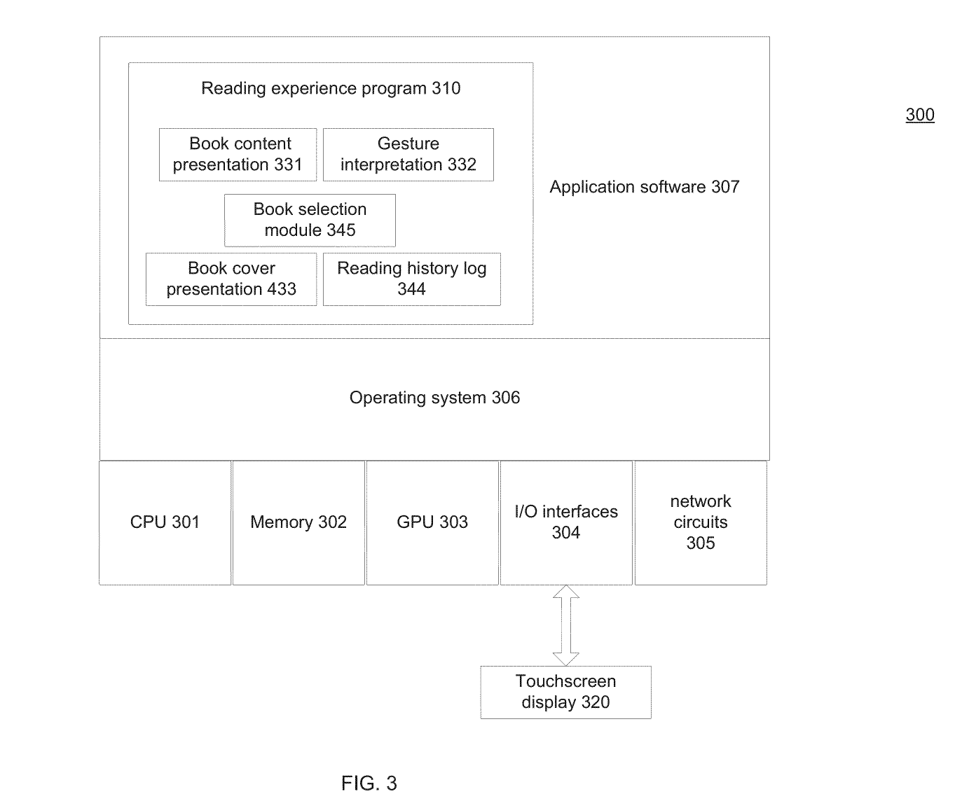

FIG. 3 is a block diagram illustrating an exemplary computing system 300 including a reading experience program 310 that can determine and present a selection of estimated user-intended readings responsive to a user gesture input according to an embodiment of the present disclosure. The computing system 300 comprises a processor 301, system memory 302, a GPU 303, I/O interfaces 304, network circuits 305, an operating system 306 and application software 307 including the reading experience program 310 stored in the memory 302.

Electronic documents to be presented by the reading experience program can be stored in a secondary storage device associated with the computing system 300. In some other embodiments, the computing system 300 may also be coupled to a server (not shown) through a communication channel. Electronic documents to be presented by the reading experience program can be stored in and accessed from the server. The server may be hosted by an on-line book store, a library, a publisher, or other electronic document content provider, etc.

The computing system 300 is equipped with a touchscreen display 320 coupled to the processors 301 and 303 through an I/O interface 304. For purposes of implementing this disclosure, any well known touch screen technology can be used to receive a specific user gesture as a user instruction to present a select plurality of reading materials (e.g., last read documents). The technology of the present disclosure is not limited by any particular type of touch-sensing or proximity-sensing mechanism employed by the touchscreen 320. The touchscreen 320 can be a resistive touchscreen, a capacitive touchscreen, an infrared touchscreen, or a touchscreen based on surface acoustic wave technology, etc. A user gesture input through a touchscreen can be detected, processed, and interpreted by any suitable mechanism that is well known it the art.

In the illustrated example, the reading experience program 310 comprises a book content presentation module 341, a gesture interpretation module 342, a visual object presentation module 343 and a reading history log 344.

When incorporating configuration input and personalized input and executed by the CPU 301, the reading experience program 310 can present book content in a reading experience GUI by performing the book content presentation module 341. Upon a pinch-in gesture input being detected through the touchscreen 320, an indication of the pinch-in gesture is received and processed by the gesture interpretation module 342.

The reading history log 344 may be configured to record the reading materials that have been displayed by using the reading experience program 310, wherein each reading material may be associated with a user identification, a reading time, a subject category, last-read document directory, etc. In response to the gesture input, the book selection module 345 accesses the reading history log and determines a set of books as estimated user-intended books based on a predetermined algorithm and standard (e.g., based on the time of the reading sessions, or the reading frequencies of the documents).

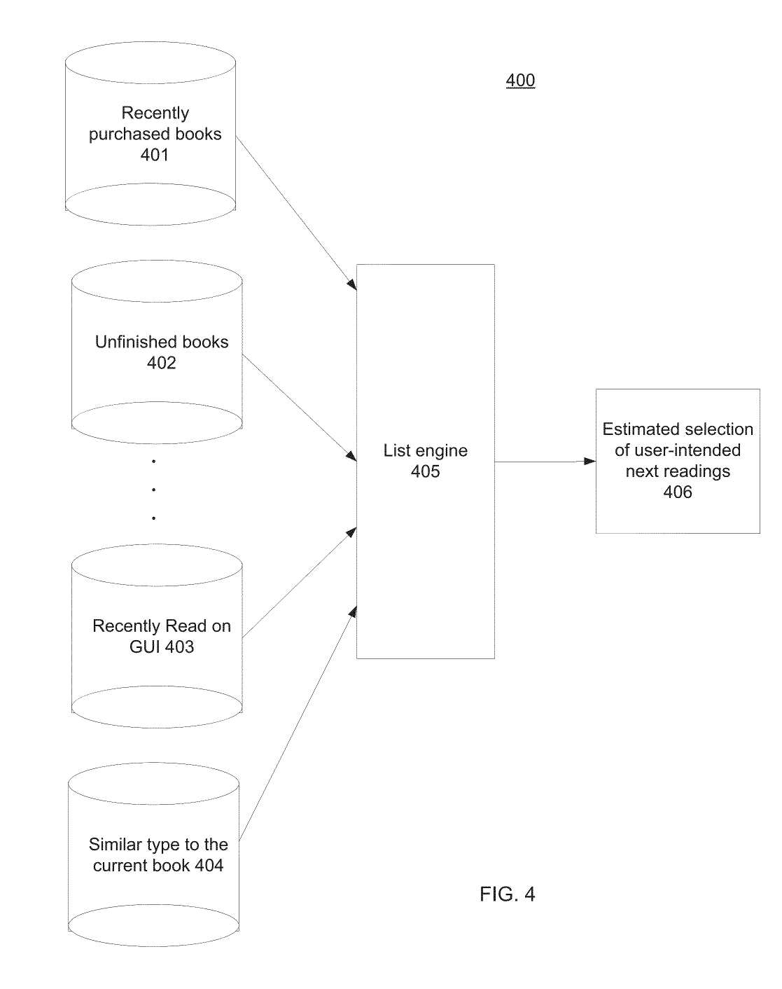

The visual object module 343 is configured to render a plurality of visual objects (e.g., by accessing the book covers of the selected documents), each reprehensive of a corresponding document in the selected set. The reading experience program 310 may perform various other functions as discussed in details with reference to FIG. 1A-1E, FIG. 2 and FIG. 4. As will be appreciated by those with ordinary skill in the art, the reading experience program 310 including the various function modules 341-345 can be implemented in any one or more suitable programming languages that are known to those skilled in the art, such as C, C++, Java, Python, Perl, C#, SQL, etc.

FIG. 4 illustrates an exemplary method 400 of determining a set of estimated user intended next readings in accordance with an embodiment of the present disclosure. Method 400 may be implemented as part of the program 310 in FIG. 3 or as a separate program dedicated to the selection function. A list engine 405 is configured to select a set of books from a library, e.g., specific to a user, as estimated user intended next readings 406 responsive to a user gesture that is discussed in greater detail above. As shown, the library of books is classified into several types or categories, including the recently purchased books 401, the unfinished books 402, recently read on GUI 403 and the similar type to the current book 404. The list engine may determine the set of books for presenting based on a criteria and algorithm. The criteria may be configurable by the user through the reading program. For example, the set of books can only be selected from one category, or a combination of selected categories from 401-404.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of presenting electronic books via a touch sensitive display, said computer implemented method comprising:
rendering on said touch sensitive display an on-screen graphical user interface (GUI) that facilitates electronic reading;
displaying content of a first electronic book within said on-screen GUI;
receiving a user instruction during said displaying;
identifying a plurality of electronic books that have displayed on said on-screen GUI prior to said displaying content of said first electronic book; and
responsive to said user instruction, contemporaneously rendering a plurality of user-selectable objects within said on-screen GUI, wherein each user-selectable object represents a respective electronic book of said plurality of electronic books.

2. The computer implemented method of claim 1, wherein said user instruction corresponds to a user multi-point touch pinch gesture detected via said touch sensitive display.

3. The computer implemented method of claim 1, wherein said plurality of electronic books comprises a second electronic book, and further comprising:
detecting an indication of a user selection on a user-selectable object that represents said second electronic book;
responsive to said user selection, accessing content of said second electronic book; and
displaying said content of said second electronic book within said on-screen GUI.

4. The computer implemented method of claim 3, wherein said user selection comprises a user tap gesture detected via said touch sensitive display.

5. The computer implemented method of claim 3 further comprising:
responsive to another user instruction, removing said plurality of user-selectable objects from said on-screen GUI; and
subsequent to said removing, displaying content of said first electronic book on said on-screen GUI.

6. The computer implemented method of claim 5, wherein said another user instruction corresponds to a user multi-point touch expand gesture detected via said touch sensitive display.

7. The computer implemented method of claim 1, wherein said plurality of electronic books comprise at least four electronic books that have been previously displayed within said on-screen GUI immediately before said content of said first electronic book.

8. The computer implemented method of claim 1, wherein said plurality of user-selectable objects are arranged in a predetermined pattern within said on-screen GUI.

9. A non-transitory computer-readable storage medium embodying instructions that, when executed by a processing device, cause the processing device to perform a method of facilitating user selection of an electronic document for reading, said method comprising:
rendering an on-screen graphical user interface (GUI) for reading on said touchscreen display device;
displaying content of a first electronic document within said on-screen GUI;
receiving a user instruction;
responsive to said user instruction, identifying a select plurality of electronic documents that were previously read using said on-screen GUI prior to said displaying content of said first electronic documents; and
responsive to said user instruction, rendering a plurality of visual objects within said on-screen GUI, wherein each visual object represents a respective electronic document of said select plurality of electronic documents.

10. The non-transitory computer-readable storage medium of claim 9, wherein said method further comprises:
detecting a user interaction with a visual object of said plurality of visual objects, said visual object representing a second electronic document; and
responsive to said user interaction, switching to display content of said second electronic document in said on-screen GUI.

11. The non-transitory computer-readable storage medium of claim 10, wherein said user instruction corresponds to a user pinch-in gesture detected via said touchscreen display device.

12. The non-transitory computer-readable storage medium of claim 11, wherein said indication is independent of an orientation and a location of said user pinch-in gesture with reference to said on-screen GUI.

13. The non-transitory computer-readable storage medium of claim 11, wherein said method further comprises:
detecting an indication of a user pinch-out gesture while said plurality of visual objects are being displayed in said on-screen GUI;
removing said plurality of visual objects from said on-screen GUI; and
re-displaying content of said first electronic document in said on-screen GUI.

14. The non-transitory computer-readable storage medium of claim 9, wherein said first electronic document is selected from a group consisting of an electronic book, an electronic magazine, a text file, and an electronic newspaper.

15. The non-transitory computer-readable storage medium of claim 9, wherein said select plurality of electronic documents were recently displayed in said on-screen GUI.

16. A system comprising:
a touch sensitive display device configured to detect user gesture input;
a processor coupled to said touch sensitive display device;
memory coupled to said processor and comprising instructions that, when executed by said processor, cause the system to perform a method of displaying content related to electronic books, said method comprising:
rendering an on-screen graphical user interface (GUI) for reading on said touch sensitive display device;
displaying content of a first electronic book on said on-screen GUI;
detecting an indication of a user gesture via said touch sensitive display device during said displaying;
identifying a plurality of electronic books that were read using said on-screen GUI prior to said displaying content of said first electronic book, said plurality of electronic books comprising a second electronic book; and
responsive to said detecting, contemporaneously rendering a plurality of user-selectable objects in said on-screen GUI, wherein each user-selectable object represents a respective electronic book of said plurality of electronic books;
receiving a user selection on a user-selectable object that selects said second electronic book; and
displaying content of said second electronic book in said on-screen GUI.

17. The system of claim 16, wherein said user gesture is a multi-point touch pinch gesture.

18. The system of claim 16, wherein said method further comprises:
responsive to a user instruction, removing said plurality of user-selectable objects from said on-screen GUI; and
re-displaying content of said first electronic book in said on-screen GUI.

19. The system of claim 16, wherein said user instruction corresponds to a multi-point touch expand gesture via said touch sensitive display device.

20. The system of claim 16, wherein said touch sensitive display device comprises proximity sensors configured to detect said user gesture.
